(19) United States
(12) Patent Application Publication
(10) Pub. No.: US 2020/0394704 A1
(43) Pub. Date: Dec. 17, 2020

(54) FACIAL MEASUREMENT SYSTEM FOR REMOTE FRAME STYLING

(71) Applicant: VPH Intellectual Property, LLC, Palm City, FL (US)

(72) Inventor: C. Brad Brocwell, Waynesville, OH (US)

(21) Appl. No.: 16/438,396

(22) Filed: Jun. 11, 2019

(51) Int. Cl. G06Q 30/06; G06F 16/535; G06F 16/538; G06F 16/9535; G06T 11/60; G06K 9/00

(52) U.S. Cl. CPC G06Q 30/0643; G06F 16/535; G06F 16/538; G06K 7/1413; G06T 11/60; G06K 9/00255; G06F 16/9535

(57) ABSTRACT

A method, system and computer program product for remote frame styling. The method includes acquiring an image of a face of a person wearing a pair of reference eyeglasses, loading eyeglass prescription data for the person and computing fitting measurements for the person from the image. The method further includes querying a data store of eyeglass frames according to the computed fitting measurements to filter the eyeglass frames to only those of the eyeglass frames meeting the computed fitting measurements and further filtering the filtered eyeglass frames to a subset of eyeglass frames validated against the prescription data. The method yet further includes retrieving an image of a selected one of the further filtered eyeglass frames, overlaying the retrieved image of the selected one of the further filtered eyeglass frames over the acquired image of the face of the person to produce a composite image, and displaying the composite image.

### BACKGROUND OF THE INVENTION

### Field of the Invention

The present invention relates to the field of eyeglass frame fitting and more particularly to remote selection of an eyeglass frame, also known as remote frame styling.

### Description of the Related Art

An eyeglass refers to a spectacle that includes both a frame and also a pair of lenses disposed within the frame. The lenses tend to be prescriptive based upon the either single vision with one power from one edge of the lens to the other and address nearsightedness, farsightedness, or astigmatism, or progressive vision with provides two or three focal points in one lens to address both near sightedness and farsightedness in one lens. With respect to progressive lenses, bifocal lenses and trifocal lenses provide, respectively, two focal points--near and distance--or three focal points: near, mid-range and distance.

Each frame is able to accommodate a particular type of lens, but depending upon the thickness and shape of lens, in some instances, only some frames can accommodate some lenses. Thus, at the outset, one must select a lens in accordance with a personal prescription before selecting a frame from amongst a limited set of frames able to accommodate the selected lens. To do so can be time consuming and requiring substantive interaction with a sales associate in a retail setting. Yet, in the modern era, retail customers seeking to purchase custom eyeglasses lack the patience for such interactions and much prefer independent shopping without assistance from a sales associate. Indeed, while in-store shopping remains a prevalent mode for selecting eyeglasses for purchase, increasingly customers prefer remote shopping online over the global Internet.

### BRIEF SUMMARY OF THE INVENTION

Embodiments of the present invention address deficiencies of the art in respect to eyeglass frame selection and provide a novel and non-obvious method, system and computer program product for remote frame styling. In an embodiment of the invention, a remote frame styling method includes acquiring in memory of a computer a digital image of a face of a person wearing a pair of reference eyeglasses, loading into the memory, eyeglass prescription data for the person and computing fitting measurements for the person from the digital image. The method further includes querying a data store of eyeglass frames according to the computed fitting measurements to filter the eyeglass frames to only those of the eyeglass frames meeting the computed fitting measurements and further filtering the filtered eyeglass frames to a subset of eyeglass frames validated against the loaded prescription data. The method yet further includes selecting one of the further filtered eyeglass frames in a user interface of the computer responsive to an input by the person in the user interface and retrieving a digital image of the selected one of the further filtered eyeglass frames. Finally, the method includes overlaying the retrieved digital image of the selected one of the further filtered eyeglass frames over the acquired digital image of the face of the person to produce a composite image and displaying the composite image in the user interface of the computer.

In one aspect of the embodiment, the computing, querying, retrieving and overlaying are performed in a server disposed remotely from the computer from over a computer communications network. In another aspect of the embodiment, the fitting measurements include pupillary distance and segment height determined relative to known structural dimensions of the reference eyeglasses. In yet another aspect of the embodiment, the fitting measurements are computed by scanning a bar code affixed to the reference eyeglasses and encoding the structural dimensions of the reference eyeglasses. In a final aspect of the embodiment, the fitting measurements are computed by performing object recognition of the reference eyeglasses in the acquired digital image to identify the reference eyeglasses and locating in a table the structural dimensions stored in association with the identified reference eyeglasses.

In another embodiment of the invention, a computer data processing system is configured for remote frame styling. The system includes a host computing system having one or more computers, each with memory and at least one processor. The system further includes a digital camera communicatively coupled to the host computing system and adapted to acquire a digital image of a face of a person positioned proximately to the digital camera. Finally, the system includes a remote frame styling module that includes computer program instructions executing in the memory of the host computing system. The computer instructions are operable to acquire with the digital camera into the memory of the host computing system, a digital image of a face of a person wearing a pair of reference eyeglasses, load into the memory, eyeglass prescription data for the person, compute fitting measurements for the person from the digital image and querying a data store of eyeglass frames according to the computed fitting measurements to filter the eyeglass frames to only those of the eyeglass frames meeting the computed fitting measurements and to further filter the filtered eyeglass frames to a subset of eyeglass frames validated against the loaded prescription data. The computer program instructions yet further are operable to select one of the further filtered eyeglass frames in a user interface of the host computing system responsive to an input by the person in the user interface, retrieve a digital image of the selected one of the further filtered eyeglass frames, overlay the retrieved digital image of the selected one of the further filtered eyeglass frames over the acquired digital image of the face of the person to produce a composite image and display the composite image in the user interface of the host computing system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for remote frame styling;

FIG. 2 is a schematic illustration of a data processing system adapted for remote frame styling; and,

FIG. 3 is a flow chart illustrating a process for remote frame styling.

### DETAILED DESCRIPTION OF THE INVENTION

Embodiments of the invention provide for remote frame styling. In accordance with an embodiment of the invention, a digital photo of the face of a customer may be acquired as the customer wears a pair of reference eyeglasses in view of a camera of a kiosk such as a personal computer or an in-store self-service station. The reference eyeglasses are of known dimensions such that from the image, facial measurements may be computed in respect to a visually identifiable pupil of an eye of the customer present within the digital photo, such as pupillary distance and segment height. Once the measurements have been computed, prescription data may be retrieved for the customer and an inventory of available frames filtered to a subset of only those frames able to satisfy the computed measurements and lenses associated with the prescription. Different digital images of the lenses in the subset may be presented to the customer through a display of the kiosk and, upon the customer selecting one of the digital images, the selected digital image may be superimposed upon the digital photo of the customer (with the reference eyeglasses having been removed) so that a composition of the digital photo and selected digital image is displayed in the display of the kiosk for the benefit of the customer. The process then may repeat for other selected ones of the frames in the subset.

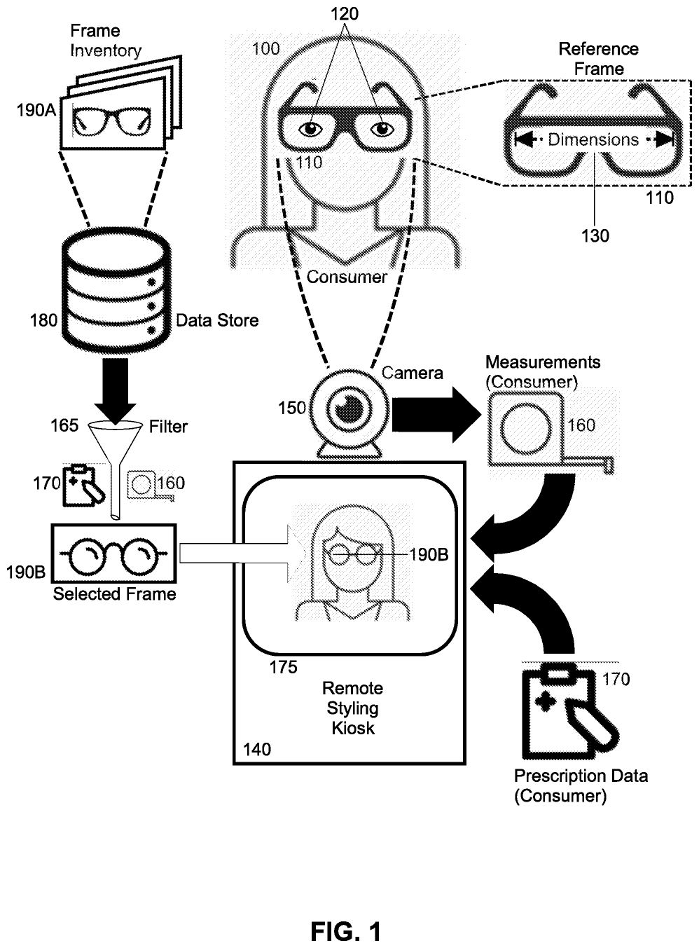

In further illustration, FIG. 1 pictorially shows a process for remote frame styling. As shown in FIG. 1, a customer 100 is positioned proximate to a remote styling kiosk 140 such as a personal computer, tablet computer, smart phone or any of the foregoing positioned remotely from a retail store environment, or internally within a retail store environment. A camera 150 positioned within the kiosk 140 acquires photographic or videographic imagery of the customer 100 as the customer 100 dons a reference frame 110. The reference frame 110 may be identified either by receiving an identifier within the kiosk 140 through keystroke input, speech recognized voice input, bar code scanning of a label on the reference frame 110, or image recognition of the reference frame 110.

Notably, the reference frame 110 is of known dimensions 130 so as to provide an accurate scale of other features evident in the imagery of the customer 100. To that end, measurements 160 of the customer 100 may be computed in respect to the known dimensions 130, such as a pupillary distance (PD) measured relative to the pupils 120 of the customer 100 image recognizable in the imagery, and also a segment height (SH) of the customer 100 measured relative to the pupils 120 of the customer 100 image recognizable in the imagery. Once the measurements 160 of the customer 100 have been computed, prescription data 170 may be retrieved for the customer 100.

With both the measurements 160 and the prescription data 170, a data store 180 of frames 190A in inventory may be subjected to a filter 165 so as to produce a subset of the frames 190A meeting the criteria of both the measurements 160 and also the prescription data 170. The subset may then be presented in a display 175 of the kiosk and the customer 100 then may select from amongst the subset, a selected frame 190B. Responsive to the selection of the selected frame 190B, a digital image of the selected frame 190B is retrieved and superimposed upon the imagery of the customer 100. In this regard, the imagery can be processed to mask out the imagery of the reference frame 110 utilizing stored imagery of the reference frame 110 and the digital image of the selected frame 190B then may be overlaid upon the imagery. Consequently, the composite imagery of the customer 100 and the imagery of the reference frame 110 is presented in the display 175 of the kiosk 140.

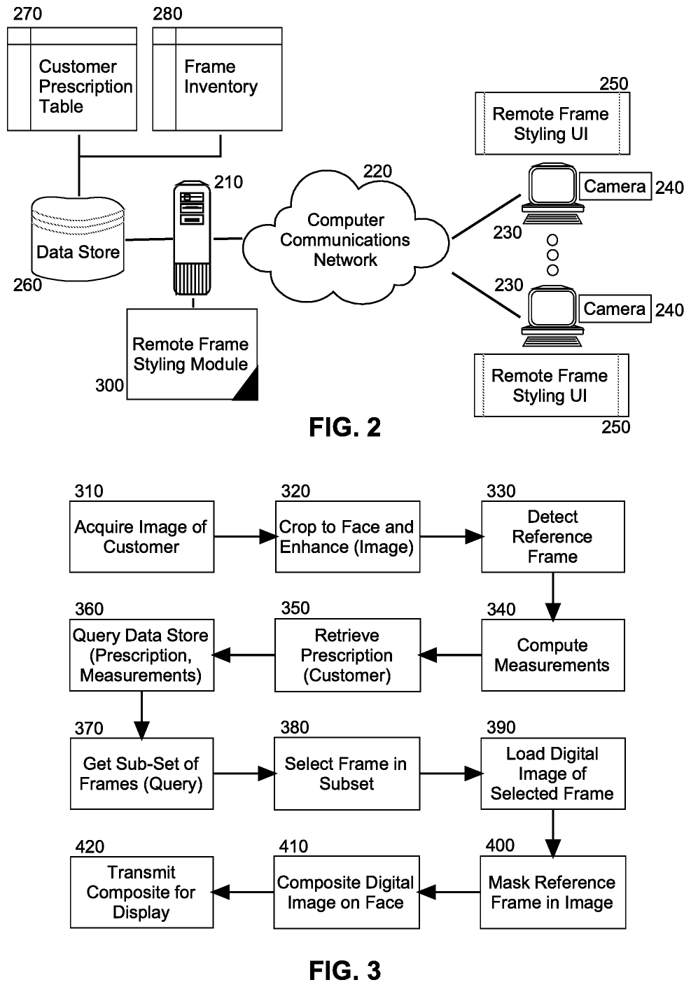

The process described in connection with FIG. 1 may be implemented in a data processing system. In yet further illustration, FIG. 2 schematically illustrates a data processing system adapted for remote frame styling. The system includes a host computing system 210 that includes one or more computers each with memory and at least one processor. The host computing system 210 is communicatively coupled to different client devices 230 over computer communications network 220. The host computing system 210 includes a data store 260 storing a table of customer prescriptions 270 mapping different customer identifiers to different eyeglass prescriptions. The data store 260 also stores therein a table of frames in inventory 280 and corresponding digital images for each of the frames.

Importantly, the system includes a remote frame styling module 300. The module 300 includes computer program instructions enabled upon execution in the memory of the host computing system 210, to receive imagery of different customers captured by different cameras 240 corresponding to different ones of the client devices 230, to compute eyeglass frame measurements for each of the different customers based upon the received imagery, to retrieve from the customer prescription table 270, prescription data for each one of the different customers, and for each one of the customers, to filter into a subset, frames in the table of frames 280 based upon the prescription data and the measurements. Thereafter, for each one of the customers, the program instructions transmit a corresponding subset to an associated one of the customers for display in a corresponding user interface 250 and responsive to selection of one of the frames in the subset, the program instructions generate a composite image of the customer and a digital image of the selected one of the frames for display in the user interface 250.

In even further illustration of the operation of the remote frame styling module 300, FIG. 3 is a flow chart illustrating a process for remote frame styling. Beginning in block 310, an image is acquired of a customer positioned proximate to a kiosk. In block 320, the image is processed to crop the imagery to include a face of the customer. As well, the image is enhanced through application of one or more image filters such as a sharpening filter, and by increasing or decreasing an exposure of the image, to name only two examples. In block 330, a reference frame worn by the customer is identified, for instance through the manual specification of the reference frame in a user interface of the kiosk, by bar code scanning a label of the reference frame, or by image recognition of an image of the reference frame in the imagery of the customer.

In block 340, customer measurements of the customer are computed relative to the known dimensions of the reference frame, including PD and SH. Then, in block 350, prescription data for the customer is retrieved from fixed storage and in block 360, a data store of inventoried frames may be queried according to the measurements and prescription data in order to produce a subset of the frames in inventory in block 370. In block 380, one of the frames in the subset is selected by the customer through the user interface in the kiosk and in block 390, a digital image of the selected frame is retrieved from fixed storage. Finally, in block 400 the appearance of the reference frame in the imagery is masked out of the image and replaced with an overlaying of the digital image of the selected image in block 410 to produce a composite image so that the composite image may be transmitted to the kiosk for display to the customer.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A remote frame styling method comprising:
acquiring in memory of a computer a digital image of a face of a person wearing a pair of reference eyeglasses of known dimensions;
identifying the reference eyeglasses of known dimensions worn by the person and loading into the memory;
loading into the memory, eyeglass prescription data for the person;
determining a scale from the known dimensions of the reference glasses relative to the digital image of the face and a measurement of dimensions of the reference eyeglasses in the digital image;
computing fitting measurements for the person from the digital image and scaling the computed measurements with the determined scale;
querying a data store of eyeglass frames according to the scaled computed fitting measurements to filter the eyeglass frames to only those of the eyeglass frames meeting the computed fitting measurements and further filtering the filtered eyeglass frames to a subset of eyeglass frames validated against the loaded prescription data;
selecting one of the further filtered eyeglass frames in a user interface of the computer responsive to an input by the person in the user interface;
retrieving a digital image of the selected one of the further filtered eyeglass frames;
overlaying the retrieved digital image of the selected one of the further filtered eyeglass frames over the acquired digital image of the face of the person to produce a composite image; and,
displaying the composite image in the user interface of the computer.

2. The method of claim 1, wherein the fitting measurements comprise pupillary distance and segment height determined relative to known structural dimensions of the reference eyeglasses.

3. The method of claim 1, wherein the computing, querying, retrieving and overlaying are performed in a server disposed remotely from the computer from over a computer communications network.

4. The method of claim 2, wherein the fitting measurements are computed by scanning a bar code affixed to the reference eyeglasses and encoding the structural dimensions of the reference eyeglasses.

5. The method of claim 2, wherein the fitting measurements are computed by performing object recognition of the reference eyeglasses in the acquired digital image to identify the reference eyeglasses and locating in a table the structural dimensions stored in association with the identified reference eyeglasses.

6. A computer data processing system configured for remote frame styling, the system comprising:
a host computing system comprising one or more computers, each with memory and at least one processor;
a digital camera communicatively coupled to the host computing system and adapted to acquire a digital image of a face of a person positioned proximately to the digital camera; and,
a remote frame styling module comprising computer program instructions executing in the memory of the host computing system, the remote computer instructions being operable to perform:
acquiring with the digital camera into the memory of the host computing system, a digital image of a face of a person wearing a pair of reference eyeglasses;
identifying the reference eyeglasses of known dimensions worn by the person and loading into the memory;
loading into the memory, eyeglass prescription data for the person;
determining a scale from the known dimensions of the reference glasses relative to the digital image of the face and a measurement of dimensions of the reference eyeglasses in the digital image;
computing fitting measurements for the person from the digital image and scaling the computed measurements with the determined scale;
querying a data store of eyeglass frames according to the scaaled computed fitting measurements to filter the eyeglass frames to only those of the eyeglass frames meeting the computed fitting measurements and further filtering the filtered eyeglass frames to a subset of eyeglass frames validated against the loaded prescription data;
selecting one of the further filtered eyeglass frames in a user interface of the host computing system responsive to an input by the person in the user interface;
retrieving a digital image of the selected one of the further filtered eyeglass frames;
overlaying the retrieved digital image of the selected one of the further filtered eyeglass frames over the acquired digital image of the face of the person to produce a composite image; and, displaying the composite image in the user interface of the host computing system.

7. The system of claim 6, wherein the fitting measurements comprise pupillary distance and segment height determined relative to known structural dimensions of the reference eyeglasses.

8. The system of claim 6, wherein the computing, querying, retrieving and overlaying are performed in one of the computers of the host computing system that is disposed remotely another of the computers of the host computing system, from the computer from over a computer communications network, in which the acquiring, loading and selecting are performed.

9. The system of claim 6, further comprising a bar code scanner, the bar code scanner scanning a bar code affixed to the reference eyeglasses and encoding the structural dimensions of the reference eyeglasses in order to compute the fitting measurements.

10. The system of claim 7, wherein the fitting measurements are computed by performing object recognition of the reference eyeglasses in the acquired digital image to identify the reference eyeglasses and locating in a table the structural dimensions stored in association with an identified reference eyeglasses.

11. A non-transitory computer readable storage medium having program instructions embodied therewith, the program instructions executable by a device to cause the device to perform a method including:
acquiring in memory of a computer a digital image of a face of a person wearing a pair of reference eyeglasses;
identifying the reference eyeglasses of known dimensions worn by the person and loading into the memory, the known dimensions;
loading into the memory, eyeglass prescription data for the person;
determining a scale from the known dimensions of the reference glasses relative to the digital image of the face and a measurement of dimensions of the reference eyeglasses in the digital image;
computing fitting measurements for the person from the digital image and scaling the computed measurements with the determined scale;
querying a data store of eyeglass frames according to the computed fitting measurements to filter the eyeglass frames to only those of the eyeglass frames meeting the scaled computed fitting measurements and further filtering the filtered eyeglass frames to a subset of eyeglass frames validated against the loaded prescription data;
selecting one of the further filtered eyeglass frames in a user interface of the computer responsive to an input by the person in the user interface;
retrieving a digital image of the selected one of the further filtered eyeglass frames;
overlaying the retrieved digital image of the selected one of the further filtered eyeglass frames over the acquired digital image of the face of the person to produce a composite image; and,
displaying the composite image in the user interface of the computer.

12. The computer program product of claim 11, wherein the fitting measurements comprise pupillary distance and segment height determined relative to known structural dimensions of the reference eyeglasses.

13. The computer program product of claim 11, wherein the computing, querying, retrieving and overlaying are performed in a server disposed remotely from the computer from over a computer communications network.

14. The computer program product of claim 12, wherein the fitting measurements are computed by scanning a bar code affixed to the reference eyeglasses and encoding the structural dimensions of the reference eyeglasses.

15. The computer program product of claim 12, wherein the fitting measurements are computed by performing object recognition of the reference eyeglasses in the acquired digital image to identify the reference eyeglasses and locating in a table the structural dimensions stored in association with the identified reference eyeglasses.
